(19) United States
(12) Patent Application Publication
(10) Pub. No.: US 2005/0145550 A1
(43) Pub. Date: Jul. 7, 2005

(54) Automatic chemical injection system for water recreational apparatus

(76) Inventors: Casey Loyd, Pomona, CA (US); Pedro Vargas, Pomona, CA (US)

Correspondence Address: SHELDON & MAK, 225 South Lake Avenue, 9th Floor, Pasadena, CA, 91101, US

(21) Appl. No.: 10/752,852

(22) Filed: Jan. 7, 2004

(51) Int. Cl. B01D 17/12

(52) U.S. Cl. 210/134; 210/169; 210/199; 137/87.01

(57) ABSTRACT

A combination for automatically adding chemicals to a water recreational apparatus, such as a spa, hot tub, swimming pool or recirculating bath tub, includes a chemical repository and one or more take off conduits for connecting the chemical repository to the water recirculation system of the water recreational apparatus. A motor operated control valve is controlled by a controller to meter the flow of chemicals into the take off conduit.

### FIELD OF THE INVENTION

This invention relates generally to water recreational apparatuses, such as spas, hot tubs, swimming pools and recirculating bath tubs.

### BACKGROUND OF THE INVENTION

Water recreational apparatuses, such as spas, hot tubs, swimming pools and recirculating bath tubs are very popular. However, such water recreational apparatuses require continual effort to maintain the quality of the body of water within the apparatus. Such maintenance entails the periodic addition of one or more chemical solutes. Heretofore, such maintenance has had to be carried out manually. Thus such maintenance is a burden for the user.

Accordingly, there is a need for a water recreational apparatus which avoids the afore-mentioned problems in the prior art, in a simple, efficient and inexpensive manner.

### SUMMARY OF THE INVENTION

The invention satisfies this need. The invention is a combination for automatically adding chemicals to a water recreational apparatus. The combination comprises a) a chemical repository; b) a chemical injection port for injecting chemicals into the basin, the chemical injection port being disposed within one of the walls of the basin; c) a take off conduit for conducting chemicals away from the chemical repository; d) a motor operated valve for controlling the flow of chemicals away from the chemical repository; e) a chemical injection conduit for connecting the take off conduit to the chemical injection port; f) conduit means for connecting the discharge side of the pump to the chemical injection conduit; and g) a controller operatively connected to the motor operated valve for opening and closing the motor operated valve at predetermined intervals to control the addition of chemicals to water within the basin.

### DESCRIPTION OF THE DRAWINGS

These and other features, aspects and advantages of the present invention will become better understood with reference to the following description, appended claims and accompanying drawings where:

FIG. 1 is a cross-sectional side view of a first water recreational apparatus having features of the invention;

FIG. 2 is a diagrammatic detail view of a combination for automatically adding chemicals to a water recreational apparatus as illustrated in FIG. 1;

FIG. 3 is a cross-sectional side view of a second water recreational apparatus having features of the invention;

FIG. 4 is a diagrammatic detail view of a combination for automatically adding chemicals to a water recreational apparatus as illustrated in FIG. 3;

FIG. 5 is a top view of a chemical repository useful in the invention; and

FIG. 6 is a side view of a chemical cartridge useable in the chemical repository illustrated in FIG. 5.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

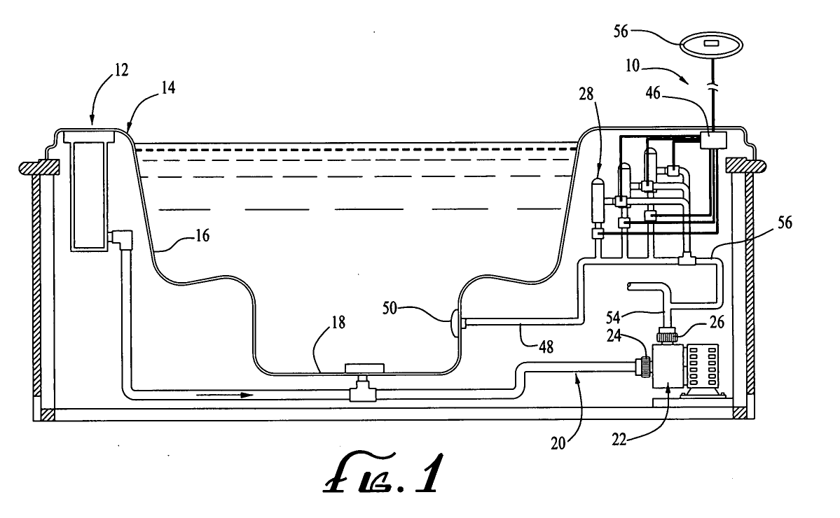

The invention is a combination 10 for automatically adding chemicals 40 to a water recreational apparatus 12. The term “water recreational apparatus” includes, but is not limited to, spas, hot tubs, swimming pools and recirculating bath tubs. The term “spas” includes prefabricated spas, such as illustrated in FIGS. 1 and 3, and custom constructed spas. Water recreational apparatuses 12 include a water basin 14. The water basin 14 is sized and dimensioned to accommodate at least one human user. The water basin 14 has side walls 16 and a bottom wall 18. The water recreational apparatus 12 further comprises a water recirculating system 20, including a recirculating pump 22 having a suction side 24 and a discharge side 26.

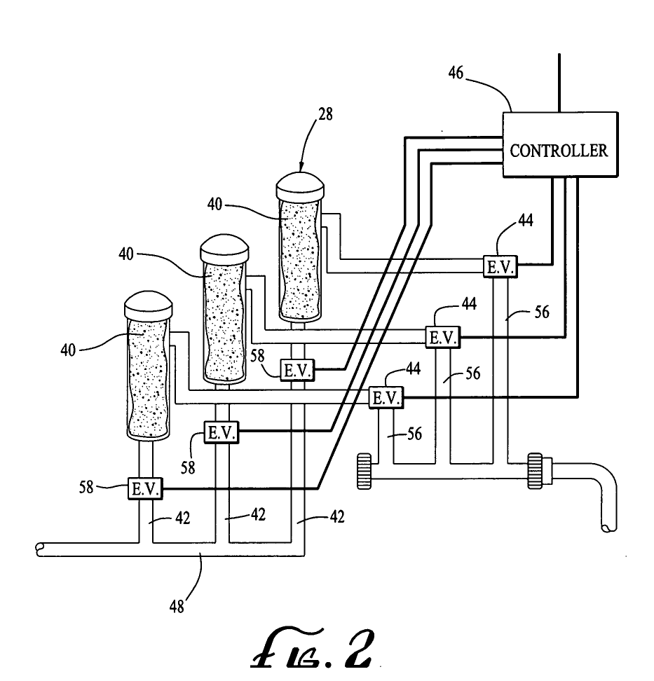

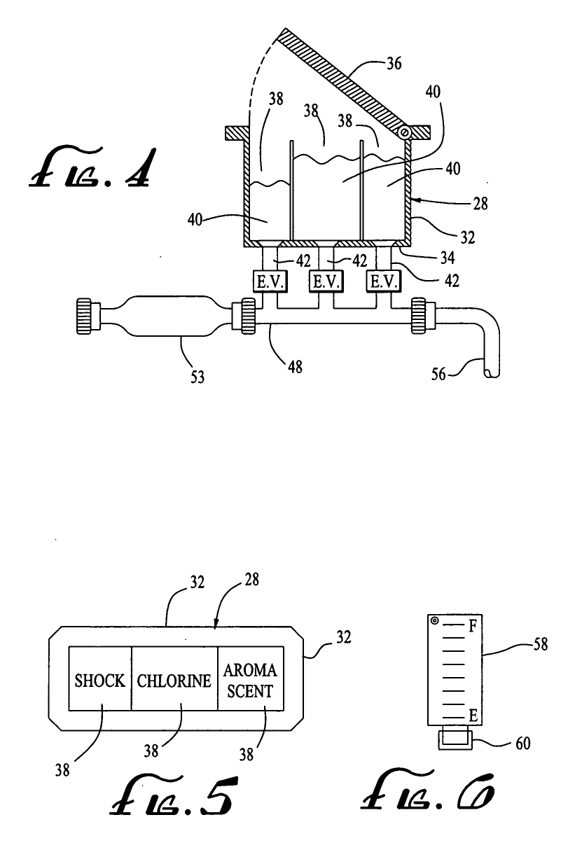

The combination 10 of the invention comprises a chemical repository 28. The chemical repository 28 can comprise one or more cylinders as illustrated in FIGS. 1 and 2. The chemical repository 28 can alternatively comprise one or more box shape bins with rectangular cross-sections as illustrated in FIGS. 3-6. In the embodiment illustrated in FIGS. 3-6, the chemical repository 28 comprises a pair of opposed vertical side walls 30, a pair of opposed vertical end walls 32, a bottom wall 34 and a hinged top wall cover 36.

The chemical repository 28 defines at least one chamber 38 for retaining water maintenance chemicals 40. In the embodiments illustrated in the drawings, the chemical repository 28 comprises three separate chambers 38, one for retaining a chlorine-precursor chemical, one for retaining a non-chlorine oxidizer and one for retaining an aroma therapy chemical. A typical chlorine precursor chemical is sodium dichloroisocynaurate dihydrate. A typical non-chlorine oxidizer is a mixture of potassium peroxymonosulfate, potassium bisulfate, potassium sulfate and magnesium carbonate. The term “aroma therapy” chemical as used in this application means any chemical which can be safely added to recirculating water within the water recreational apparatus 12 to provide the user with a pleasant aroma.

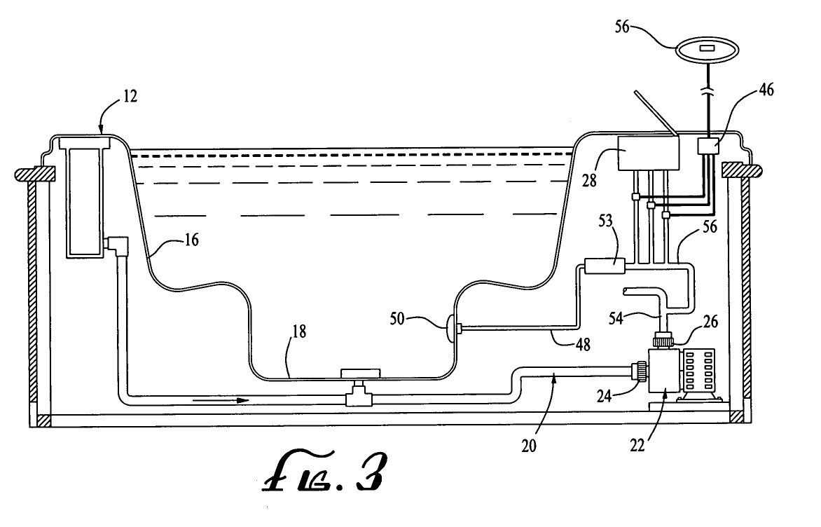

Each chamber 38 in the chemical repository 28 is connected to a take off conduit 42 for conducting chemicals away from that chamber 38 in the chemical repository 28. In the embodiment illustrated in FIGS. 4-6, each take off conduit 42 is disposed immediately below its corresponding chamber 38 so that chemicals 40 within the chamber 38 can be made to gravitate downwardly out of the chamber 38 and into the take off conduit 42.

Each take off take off conduit 38 empties into a chemical injection conduit 48. Each chemical injection conduit 48 is connected in fluid tight communication with a chemical injection port 50 defined in one of the walls 16 or 18 of the water basin 14. In a typical embodiment, the chemical injection port 50 is defined in the side walls 16 of the water basin 14 and is provided by one or more of the recirculating water jets (not shown) providing recirculated water and entrained air bubbles to the water basin 14.

When the chemicals entering the chemical injection conduit 48 are dry chemicals, it is preferable that the chemical injection conduit 48 comprises an in line mixer 53. An in line mixer 53 helps assure that dry chemicals 40 flowing into the chemical injection conduit 48 become thoroughly mixed with the with water within the chemical injection conduit 48. A typical in line mixer 53 is manufactured by Hazzei of Bakersfield, Calif., such as Model LGM-02.

The chemical injection conduit 48 is connected, upstream of its connection with the take off conduit 38, with a pump discharge conduit 54. The pump discharge conduit 54, in turn, is connected to the discharge side 26 of the recirculating pump 22.

In all embodiments of the invention, a motor operated control valve 44 is used to control the flow of chemicals away from the chemical repository 28 and into the chemical injection conduit 48. In the embodiment illustrated in FIGS. 1 and 2, such control valve 44 is installed upstream of the chemical repository 28 in a chemical repository inlet conduit 56 connecting the discharge side 26 of the pump 22 to the chemical repository 28. The use of the chemical repository inlet conduit 56 and the disposition of the motor operated control valve 44 within the chemical repository inlet conduit 56 makes the embodiment illustrated in FIGS. 1 and 2 especially suitable for use with chemicals in “caplet” or similar form. Where the chemicals are in “caplet” or similar form, the flow of water through the chemical repository 28 from the chemical repository inlet conduit 56 of the take off conduit 38 slowly leaches chemicals from the caplets stored within the chemical repository 28. The caplets can be conveniently retained within the chemical repository 28 in a porous mesh bag or similar retainer to prevent the caplets from being swept out of the chemical repository 28 all at once.

In the embodiment illustrated in FIGS. 1 and 2, it is preferable to provide a back flow prevention valve 58 into each of the take off conduits 38 to prevent the reverse flow of water through the take off conduits 38 back into the chemical repository 28. Such back flow valve 58 can be a check valve or the like. In the embodiment illustrated in FIG. 2, however, the back flow prevention valves 58 are motor operated valves.

In the embodiment illustrated in FIGS. 3-6, the motor operated valves are disposed within each of the take off conduits 28. The embodiment illustrated in FIGS. 3-6 are particularly suitable for allowing the gravitation of liquid, gel or dry chemicals down the take off conduits 38 and into the chemical injection conduit 48.

The motor operated valves 44 are typically solenoid valves, each controlled by a controller 46. The controller 46 is operatively connected to the motor operated control valves 44 for opening and closing those control valves 44 at predetermined intervals to control the addition of chemicals 40 to water within the water basin 14. In a typical embodiment, the controller 46 is a computerized digital controller, programmed to regulate the frequency of chemical additions to the water basin 14. In another embodiment, the controller 46 is programmed to regulate the amount of chemical 40 added to the water basin 46 during each addition cycle.

The controller 46 includes a control panel 56 which is typically easily accessible to a user within the water basin 14. The control panel 56 allows the user to modify the settings of the controller 46 to modify the frequency and/or amount of chemicals 40 added to water within the water basin 14.

In one embodiment of the invention, chemicals 40 are provided to the chemical repository 28 in chemical-containing cartridges 58, such as illustrated in FIG. 4. The chemical-containing cartridges 58 provide a convenient way for the user to load chemicals 40 into the chambers 38 within the chemical repository 28. In the embodiment of the cartridge 58 illustrated in FIG. 4, the user merely detaches the retaining cap 60 at the bottom of the cartridge 58 and sets the cartridge 58 into one of the chambers 38 in the chemical repository 28. When the cartridge 58 is empty, the user merely removes the cartridge 58 and replaces it with a new cartridge 58.

Many recreational apparatuses 12 comprise more than one recirculating pumps 22, including a high pressure pump 22 and a low pressure pump 22. In such systems, the user has additional options regarding the automatic injection of chemicals 40 into the water basin 14. For example, the system can be set up such that one or more of the pump discharge conduits 54 are connected only to the discharge side 26 of the high pressure pump 22 or only to the discharge side 26 of the low pressure pump 22. In other embodiments, some of the pump discharge conduits 54 are connected to the high pressure pump 22 and some to the low pressure pump 22.

The invention is also a water recreational apparatus 12, such as a prefabricated spa, having the combination 10 for automatically adding chemicals 40 to the water basin 14 described above.

Having thus described the invention, it should be apparent that numerous structural modifications and adaptations may be resorted to without departing from the scope and fair meaning of the instant invention as set forth hereinabove and as described hereinbelow by the claims.

1. A combination for automatically adding chemicals to a water recreational apparatus wherein the water recreational apparatus has a water basin and a recirculating pump, the water basin being sized and dimensioned to accommodate at least one human user, the water basin having sidewalls and a bottom wall, the recirculating pump having a suction side and a discharge side, the combination comprising:
a) a chemical repository;
b) a chemical injection port for injecting chemicals into the basin, the chemical injection port being disposed within one of the walls of the basin;
c) a take off conduit for conducting chemicals away from the chemical repository;
d) a motor operated control valve for controlling the flow of chemicals away from the chemical repository;
e) a chemical injection conduit for connecting the take off conduit to the chemical injection port;
f) conduit means for connecting the discharge side of the pump to the chemical injection conduit; and
g) a controller operatively connected to the motor operated control valve for opening and closing the motor operated control valve at predetermined intervals to control the addition of chemicals to water within the basin.

2. The combination of claim 1 further comprising a chemical repository inlet conduit connecting the discharge side of the pump to the chemical repository, and wherein the motor operated control valve is disposed within the chemical repository inlet conduit.

3. The combination of claim 2 wherein the take off conduit comprises a back flow prevention valve.

4. The combination of claim 3 wherein the back flow prevention valve is a motor operated valve controlled by the controller.

5. The combination of claim 1 wherein the chemical injection conduit comprises an in line mixer.

6. The combination of claim 1 wherein the chemical repository has multiple chambers, each chamber having a take off conduit with a motor operated valve.

7. The combination of claim 1 further comprising a chemical-containing cartridge disposed within the chemical repository.

8. The combination of claim 1 further comprising a chlorine-precursor chemical disposed within the chemical repository.

9. The combination of claim 6 wherein one of the chambers within the chemical repository contains a chlorine-precursor chemical and another chamber within the chemical repository contains a shock chemical.

10. The combination of claim 9 wherein one of the chambers within the chemical repository contains a perfume chemical.

11. The combination of claim 1 wherein the chemical injection port is an inlet jet disposed within the side walls of the water basin.

12. The combination of claim 1 wherein the water recreational apparatus comprises a plurality of pumps, including a high pressure pump and a low pressure pump, and wherein the pump discharge conduit is connected to the discharge side of the high pressure pump.

13. The combination of claim 1 wherein the controller comprises a control panel which allows the controller to be adjusted by the user to regulate the frequency of the addition of chemicals to water within the basin.

14. The combination of claim 1 wherein the controller comprises a control panel which allows the controller to be adjusted by the user to regulate the amount of chemical added to water within the basin.

15. A combination for automatically adding chemicals to a water recreational apparatus wherein the water recreational apparatus has a water basin and a recirculating pump, the water basin being sized and dimensioned to accommodate at least one human user, the water basin having sidewalls and a bottom wall, the recirculating pump having a suction side and a discharge side, the combination comprising:
a) a chemical repository;
b) a chemical injection port for injecting chemicals into the basin, the chemical injection port being disposed within one of the walls of the basin;
c) a take off conduit for conducting chemicals away from the chemical repository, the take off conduit including a motor operated valve for preventing back flow into the chemical repository;
d) a chemical injection conduit for connecting the take off conduit to the chemical injection port;
e) a chemical repository inlet conduit connecting the discharge side of the pump to the chemical repository;
f) conduit means for connecting the discharge side of the pump to the chemical injection conduit, the conduit means including a motor operated control valve for controlling the flow of liquids into the chemical repository; and
g) a controller operatively connected to the motor operated valves for opening and closing the motor operated valves at predetermined intervals to control the addition of chemicals to water within the basin.

16. The combination of claim 15 wherein the chemical repository has multiple chambers, each chamber having a take off conduit for conducting chemicals away from the chamber and conduit means for connecting the discharge side of the pump to the chamber, both the take off conduit and the conduit means for connecting the discharge side of the pump to the chamber having motor control operated valves controlled by the controller.

17. The combination of claim 15 wherein the water recreational apparatus comprises a plurality of pumps, including a high pressure pump and a low pressure pump, and wherein the pump discharge conduit is connected to the discharge side of the high pressure pump.

18. The combination of claim 15 wherein the controller comprises a control panel which allows the controller to be adjusted by the user to regulate the frequency of the addition of chemicals to water within the basin.

19. A combination for automatically adding chemicals to a water recreational apparatus wherein the water recreational apparatus has a water basin and a recirculating pump, the water basin being sized and dimensioned to accommodate at least one human user, the water basin having sidewalls and a bottom wall, the recirculating pump having a suction side and a discharge side, the combination comprising:
a) a chemical repository having multiple chambers;
b) at least one chemical injection port for injecting chemicals into the basin, the chemical injection port being disposed within one of the walls of the basin;
c) a plurality of take off conduits, one conduit being attached to each of the chambers within the chemical repository for conducting chemicals away from each chamber, each take off conduit including a motor operated control valve;
d) a chemical injection conduit for connecting the take off conduit to the chemical injection port, the chemical injection conduit including an in line mixer;
e) a pump discharge conduit for connecting the discharge side of the pump to the chemical injection conduit;
f) a controller operatively connected to the motor operated control valve for opening and closing the motor operated control valve at predetermined intervals to control the addition of chemicals to water within the basin, the controller comprising a control panel which allows the user to adjust the frequency of the addition of chemicals to water within the basin; and
g) a control panel for allowing the controller to be adjusted by the user to regulate the amount of chemical added to the water within the basin.

20. The combination of claim 19 further comprising a chemical-containing cartridge disposed within the chemical repository.
